(19) United States
(12) Patent Application Publication
(10) Pub. No.: US 2025/0371923 A1
(43) Pub. Date: Dec. 4, 2025

(54) SADDLE SHAPED DEFLECTOR FOR A STORAGE APPARATUS

(71) Applicant: Crane Payment Innovations, Inc., Malvern, PA (US)

(72) Inventors: Colm Aloysius Monaghan, Buxtehude (DE); Wladislaw Merems, Stade (DE); Stig Goepel, Osten (DE)

(21) Appl. No.: 19/301,793

(22) Filed: Aug. 15, 2025

Related U.S. Application Data
(63) Continuation-in-part of application No. PCT/US2024/023450, filed on Apr. 5, 2024.

(51) Int. Cl. G07D 9/00; G07D 1/02

(52) U.S. Cl. CPC G07D 9/00; G07D 1/02; G07D 2201/00

(57) ABSTRACT

An object deflector for installation within a storage apparatus. The object deflector includes an attachment portion for coupling the object deflector to the storage apparatus. The object deflector also includes a deflection ramp that is saddle shaped. The deflection ramp extends from the attachment portion. The deflection ramp is operable to receive an object entering the storage apparatus and direct the object to an interior portion of the storage apparatus.

### CROSS-REFERENCE TO RELATED APPLICATIONS

This application is a Bypass Continuation in Part of International Application No. PCT/US2024/023450, filed Apr. 5, 2024, the disclosure of which is herein incorporated by reference in its entirety.

### TECHNICAL FIELD

This disclosure relates generally to automated storage systems. More specifically, this disclosure relates to a saddle shaped deflector for a storage apparatus.

### BACKGROUND

Apparatuses for receiving and storing a large number of objects have been found to have certain defects. For example, previous storage apparatuses coupled to an object transport system may receive objects into the storage apparatus with poor object distribution, such that the objects tend to pile up in one or more particular areas of the storage apparatus, while other areas of the storage apparatus have no objects or fewer objects. This poor object distribution can cause the opening of the storage apparatus to be obstructed, preventing more objects to be deposited into the storage apparatus, even though the storage apparatus is not yet full. This is especially evident when the opening is placed near the periphery of the storage apparatus and the storage apparatus has a low height with respect to the overall area.

### SUMMARY

This disclosure provides a saddle shaped deflector for a storage apparatus.

In one aspect, an object deflector for installation within a storage apparatus includes an attachment portion for coupling the object deflector to the storage apparatus. The object deflector also includes a deflection ramp extending from the attachment portion and operable to receive an object entering the storage apparatus and direct the object to an interior portion of the storage apparatus. The deflection ramp is saddle shaped.

In another aspect, a method of an object deflector installed within a storage apparatus, wherein the object deflector includes an attachment portion for coupling the object deflector to the storage apparatus and a deflection ramp extending from the attachment portion, includes receiving, by the deflection ramp of the object deflector, an object entering the storage apparatus. The method also includes directing, by the deflection ramp, the object along a length of the deflection ramp. The method also includes directing, by the deflection ramp, the object to an interior portion of the storage apparatus. The deflection ramp of the object deflector is saddle shaped.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIGS. 1A-1D illustrate views of an example saddle shaped deflector for a storage apparatus in accordance with this disclosure;

FIGS. 2A and 2B illustrate an example configuration of a saddle shaped deflector mounted within a storage apparatus in accordance with this disclosure;

FIGS. 3A-3C illustrate views of an example payment apparatus including a saddle shaped deflector within a storage apparatus in accordance with this disclosure;

FIG. 4 illustrates an example method for an object deflector in accordance with this disclosure;

FIGS. 5A and 5B illustrate views of another example saddle shaped deflector for a storage apparatus in accordance with this disclosure; and

FIG. 6 illustrates a cross-sectional view of a portion of a payment apparatus that includes a storage apparatus and the saddle shaped deflector of FIGS. 5A and 5B.

### DETAILED DESCRIPTION

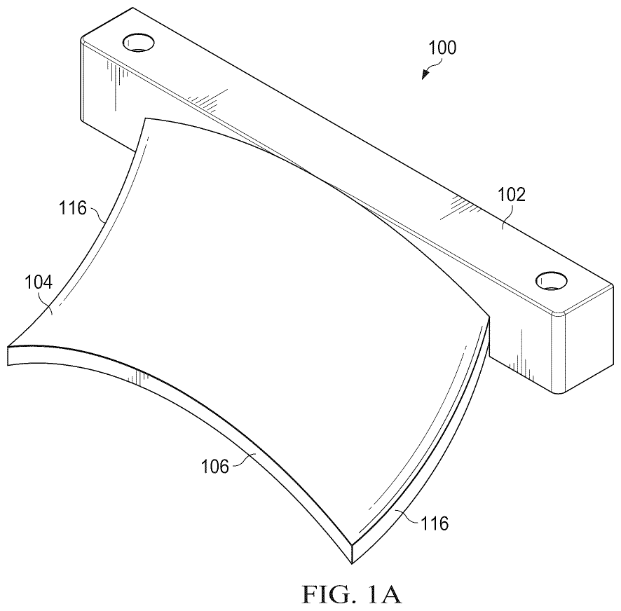

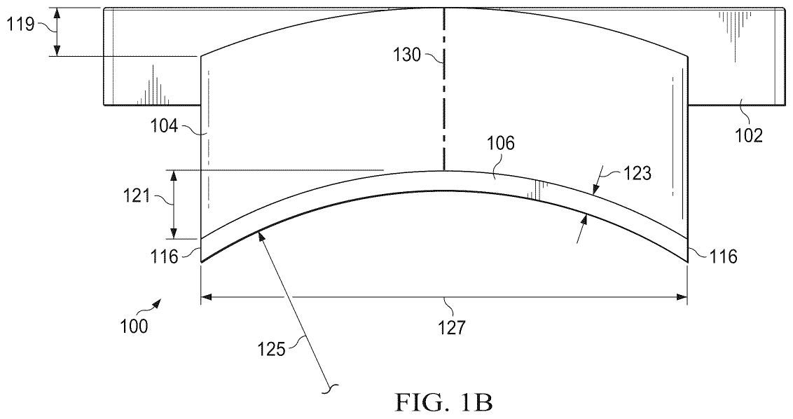

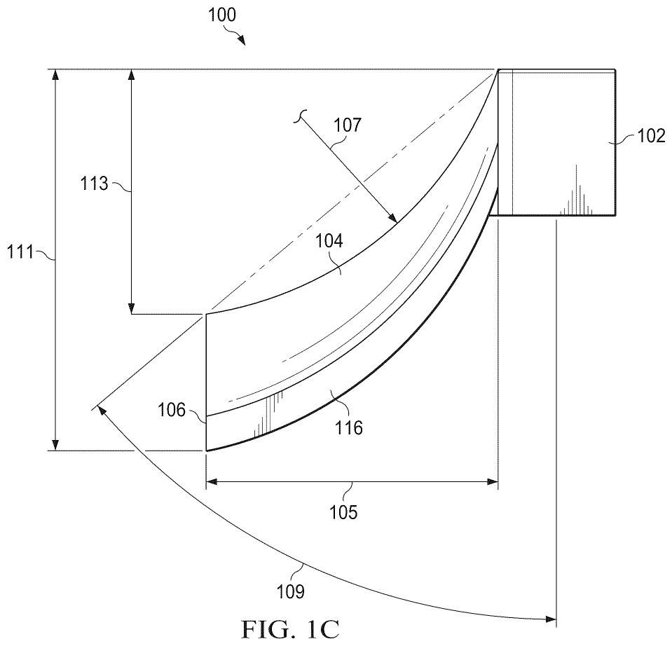

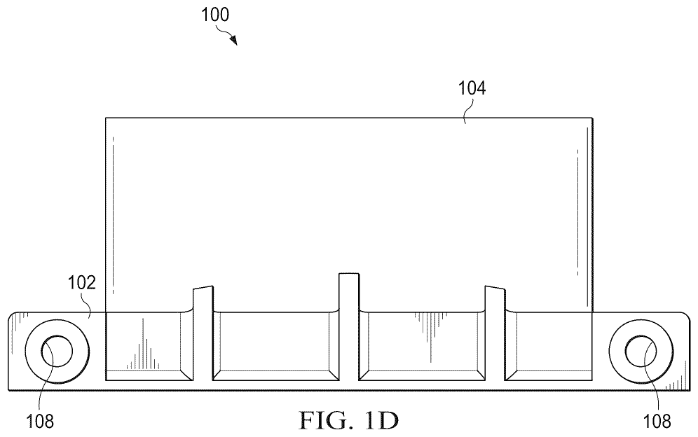

FIGS. 1 through 6, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, apparatuses for receiving and storing a large number of objects have been found to have certain defects. For example, previous storage apparatuses coupled to an object transport system may receive objects into the storage apparatus with poor object distribution, such that the objects tend to pile up in one or more particular areas of the storage apparatus, while other areas of the storage apparatus have no objects or fewer objects. This poor object distribution can cause the opening of the storage apparatus to be obstructed, preventing more objects to be deposited into the storage apparatus, even though the storage apparatus is not yet full. This is especially evident when the opening is placed near the periphery of the storage apparatus and the storage apparatus has a low height with respect to the overall area.

FIGS. 1A-1D illustrate views of an example saddle shaped deflector 100 for a storage apparatus in accordance with this disclosure. FIG. 1A is a front perspective view of the saddle shaped deflector 100, FIG. 1B is a front view of the saddle shaped deflector 100, FIG. 1C is a side view of the saddle shaped deflector 100, and FIG. 1D is a bottom view of the saddle shaped deflector 100. It will be understood that the saddle shaped deflector 100 can be used in a variety of environments to receive and transition objects into a storage apparatus. For example, the saddle shaped deflector 100 could be used in various apparatuses in which objects are deposited and accumulated into a designated storage area, such as automated currency or payment machines, gaming machines that transport and/or store small objects such as marbles, food/produce storage machines that store small items (e.g., coffee beans), quarrying equipment where rocks, gravel, coal, sand, salt, etc. are stacked in a given area, candy/gumball machines, toy machines, etc.

As shown in FIG. 1A, the saddle shaped deflector 100 includes an attachment bar 102 for coupling the saddle shaped deflector 100 to a storage apparatus. For example, the saddle shaped deflector 100 can be coupled to an interior wall of a storage apparatus and receive objects via a deposit opening such as an aperture, tunnel, chute, and/or other structures that allow for the objects to be deposited into the storage apparatus. For instance, the storage apparatus could be part of an apparatus or machine that receives the objects and transports the objects via an object transportation system through the machine and into the storage apparatus.

The deflector 100 also includes a saddle shaped deflection ramp 104 having a front edge 106 and two side edges 116. An object received into the storage apparatus comes into contact with the saddle shaped deflector 100, being initially received by a portion of a deflection ramp 104. The objects received onto the deflection ramp 104 slide off either the front edge 106 or one of the side edges 116 of the deflection ramp 104 and are directed further into an interior of the storage apparatus. The deflection ramp 104 of the saddle shaped deflector 100 is a curved surface without any flat, parallel, or perpendicular surfaces, as shown in FIGS. 1A-1D. The surface does not contain any straight lines or angles. In one embodiment the curved surface of the deflection ramp 104 of the deflector 100 is negatively curved. In one embodiment the curved surface of the deflection ramp 104 of the deflector 100 is a hyperbolic paraboloid, which is a negatively curved surface without any flat, parallel, or perpendicular surfaces.

The saddle shape of the deflection ramp 104 allows for objects to be directed into specific parts of the storage apparatus to achieve efficient filling throughout the storage apparatus. The shape of the deflection ramp 104 of the saddle shaped deflector 100 allows for objects to be directed into specific parts of the storage apparatus to achieve efficient filling throughout the storage apparatus. This continuous sloping shape also prevents the objects from bouncing and hitting other surrounding parts at the opening or entry of the storage apparatus as bouncing of an object from flat and angular surfaces can remove the energy from the object as it moves into storage area leading to inefficient piling and can cause the opening or entry of the storage apparatus to be obstructed, preventing more objects to be deposited into the storage apparatus, even though the storage apparatus is not yet full.

The direction in which the object flows off the deflection ramp 104 is assisted by the form of the deflection ramp 104 being negatively contoured away from the central axis of the deflector (i.e., the object travel direction) and because the deflection ramp 104 is symmetrical about a vertical plane through this central axis. This dished shape can also prevent objects from tipping upon impact with the deflector 100. This is advantageous, as this prevents a double impact of the object on the deflector 100 before progressing to the rear of the storage apparatus. In this way, any loss of kinetic energy by the object is minimized and the object can travel further into the storage apparatus, aiding the even distribution of the objects within the storage apparatus. In other words, parts of the storage apparatus farther from the opening will fill first, allowing a larger number of objects to enter the storage apparatus as the objects pile from the farther areas of the storage area back to near the deflection ramp 104.

FIGS. 1B-1D show various orientations of the saddle shaped deflector 100. As shown in FIG. 1B, deflection ramp 104 of the saddle shaped deflector 100 is shown as having a linear height 119 from side edge 116 to the top of the back side of the deflection ramp 104 where it joins to the attachment bar 102. A top surface of the deflection ramp 104 also includes a linear height 121 from a lowest point of the curve of the front edge 106 to a highest point of the curve of front edge 106. The deflection ramp 104 has a thickness 123 at front edge 106. The front edge 106 of deflection ramp 104 also has a radius of curvature 125. The deflection ramp 104 also has a linear width 127 as measured from a left end to a right end of the deflection ramp 104, as shown in FIG. 1B.

As shown in FIG. 1C, the deflection ramp 104 of the saddle shaped deflector 100 has a linear length extending from the attachment bar 102 to the front edge 106. The saddle shaped deflector 100 also includes a linear height 113 of a top-most point of the curve of front edge 106 of the deflection ramp 104 to a top side of the deflection ramp 104 where it joins the attachment bar 102. The deflection ramp 104 has a radius of curvature 107 at a vertical plane through center line 130 (in FIG. 1B). The saddle shaped deflector 100 also includes an angle 109 as shown in FIG. 1C. Similarly, the deflection ramp 104 also includes a linear height 111 of a bottom-most point of the curve of the front edge 106 of deflection ramp 104 to a top side of the deflection ramp 104 where it joins to the attachment bar 102.

As shown in FIG. 1D, the attachment bar 102 can include one or more coupling apertures 108 used to couple the saddle shaped deflector 100 to a storage apparatus, such as at a top internal surface of a storage apparatus. The coupling apertures 108 can be used to couple the attachment bar 102 using various fixation devices such as a screw, bolt, etc.

Although FIGS. 1A-1D illustrate an example saddle shaped deflector 100, various changes may be made to FIGS. 1A-1D. For example, it will be understood that FIGS. 1B-1D are merely examples to demonstrate an example construction of the deflector 100, and other arrangements can be used while retaining the general and beneficial shape of the saddle shaped deflector 100 without departing from the scope of this disclosure. Attachment bar 102 can have any shape and size that accommodates the configuration of the storage apparatus. As such, the shape and size of the attachment bar 102 shown in FIGS. 1B-1D should not be considered limiting. Additionally or alternatively, in some embodiments, the attachment bar 102 can include the coupling apertures 108 at a rear side of the attachment bar 102, such as to allow for coupling of the attachment bar 102 to a side wall of the storage apparatus. In some embodiments, the deflector 100 is part of the storage apparatus, such as being a molded as part of the wall of the storage apparatus, i.e., the deflector 100 is not coupled via an attachment mechanism. The saddle shaped deflector 100 can be made from a variety of materials that allow for the surface of the deflection ramp 104 to be smooth.

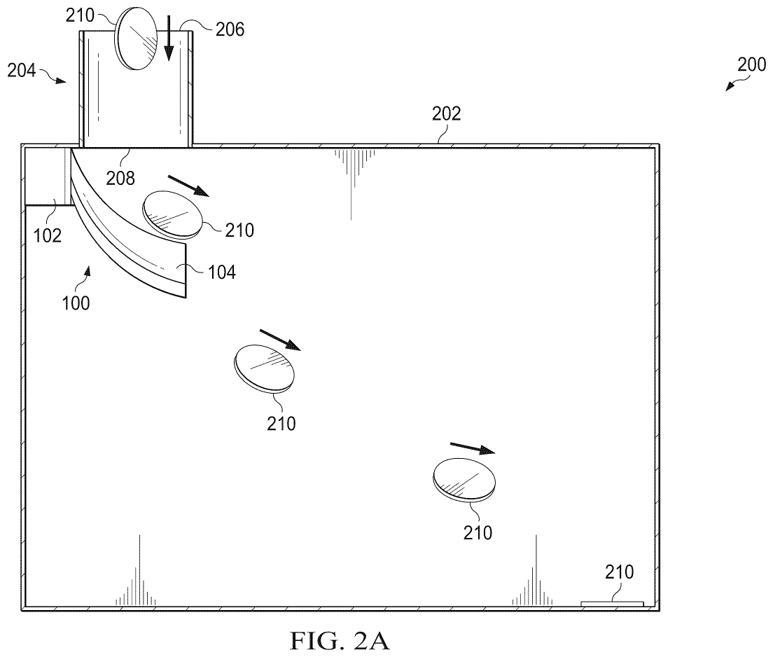

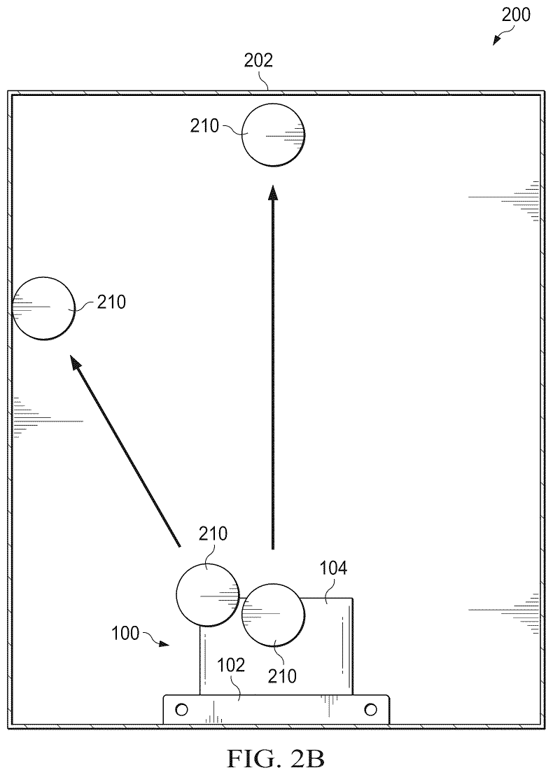

FIGS. 2A and 2B illustrate an example configuration 200 of a saddle shaped deflector 100 mounted within a storage apparatus 202 in accordance with this disclosure. As shown in FIG. 2, the saddle shaped deflector 100 is coupled to a top interior surface within the storage apparatus 202 via the attachment bar 102. Although illustrated at a top left corner of the storage apparatus 202 in FIG. 2A, it will be understood that the saddle shaped deflector 100 can be mounted in other locations within the storage apparatus 202 depending on the nature of the device in which the saddle shaped deflector 100 is installed, such as the location of an entrance into the storage apparatus.

The storage apparatus 202 includes an entry structure 204. In various embodiments of this disclosure, the entry structure 204 can include an aperture, tunnel, chute, ramp, and/or other structures. In the example of FIG. 2A, the entry structure includes a chute or tube 206 ending at an aperture 208 leading into the storage apparatus 202. It will be understood that the storage apparatus 202 can be a part of a larger machine or apparatus that includes object transportation components that move objects through the machine or apparatus and to the entry structure 204. As objects 210 are transported through the entry structure 204, the saddle shaped deflector 100 receives the objects 210 coming into contact with the saddle shaped deflector 100, being initially received by a portion of a deflection ramp 104. The objects 210 received onto the deflection ramp 104 slide off the deflection ramp 104 and are directed to an interior location within the storage apparatus 202, generally in a longitudinal direction towards an end of the storage apparatus opposite to the end of the storage apparatus where the deflector 100 is mounted.

In some embodiments, the deflection ramp 104 of the saddle shaped deflector 100 is shaped to be a hyperbolic paraboloid having a negatively curved surface without any flat, parallel, or perpendicular surfaces. The shape of the deflection ramp 104 of the saddle shaped deflector 100 allows for objects to be directed into specific parts of the storage apparatus 202 to achieve efficient filling throughout the storage apparatus. In various embodiments, for example as shown in FIG. 2B, the curved surface of the deflection ramp 104 of the deflector 100 allows the objects 210 to be directed to the central back portion of the storage apparatus 202, or to the rear corners of the storage apparatus 202, such as when an object 210 moves off the deflection ramp 104 at one side or the other of the deflection ramp 104. The direction in which objects flow off the deflection ramp 104 is thus assisted by the form of the deflection ramp 104 being negatively contoured away from the center axis of the deflector and because the deflection ramp 104 is symmetrical. This dished shape can also prevent objects from tipping upon impact with the deflector 100. This is advantageous, as this prevents a double impact of the objects on the deflector 100 before progressing to the rear of the storage apparatus. In this way, the objects lose the least amount of kinetic energy and can travel further into the storage apparatus, aiding the even distribution of the objects within the storage apparatus.

A common problem, especially with shorter storage apparatuses, is that the distribution of the objects is critical to it achieving its function. The geometry of the surface of the deflection ramp 104 thus allows the deflector 100 to work efficiently, with the sloping form stopping objects from bouncing.

Although FIGS. 2A and 2B illustrate an example configuration 200 of a saddle shaped deflector 100 mounted within a storage apparatus 202, various changes may be made to FIG. 2. For example, it will be understood that the saddle shaped deflector 100 and the storage apparatus 202 can be configured to operate within a variety of environments, such as a variety of larger machines or apparatuses, and can be used to transport and deposit a variety of different objects into and within the storage apparatus 202, depending on the type of apparatus or machine in which the saddle shaped deflector 100 and the storage apparatus 202 are used.

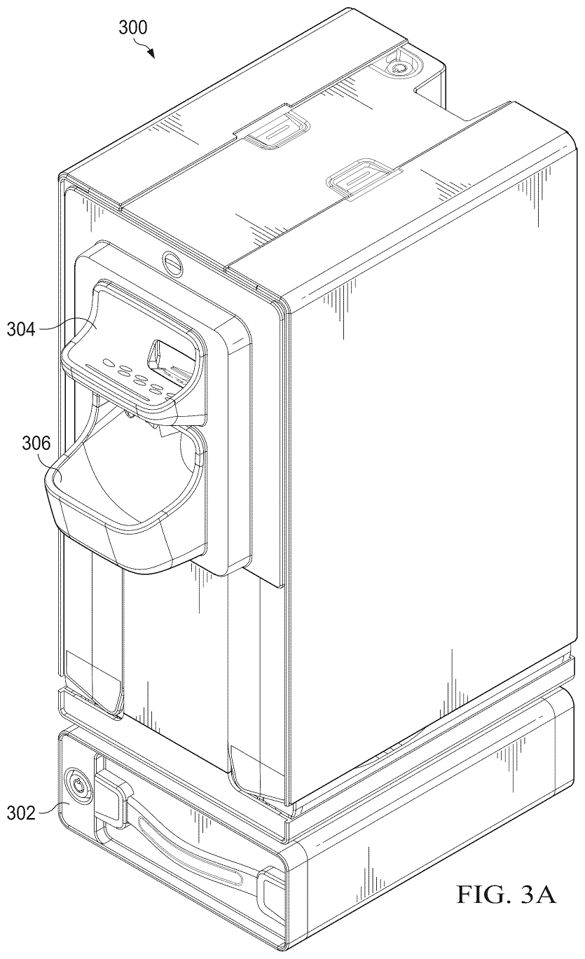

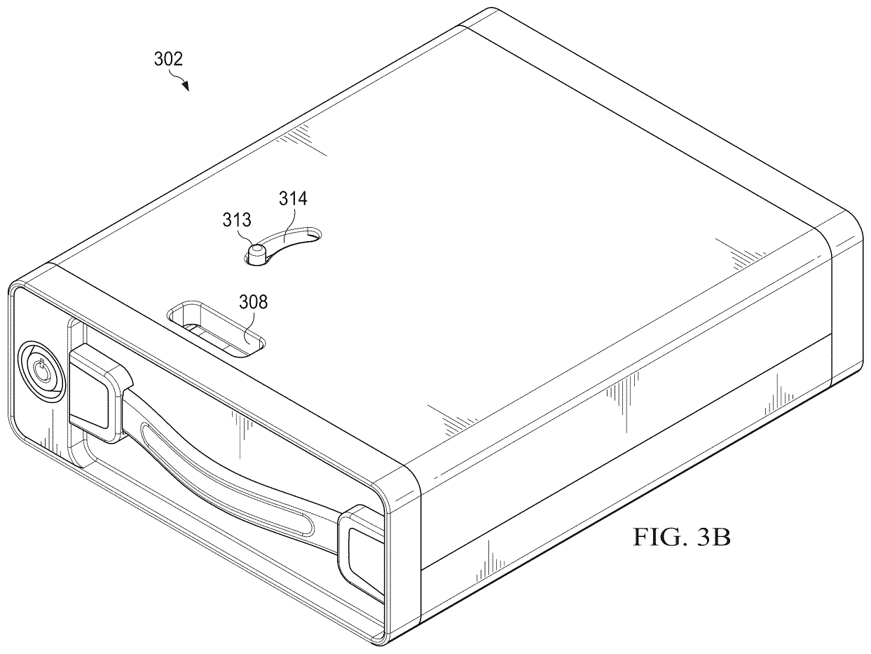

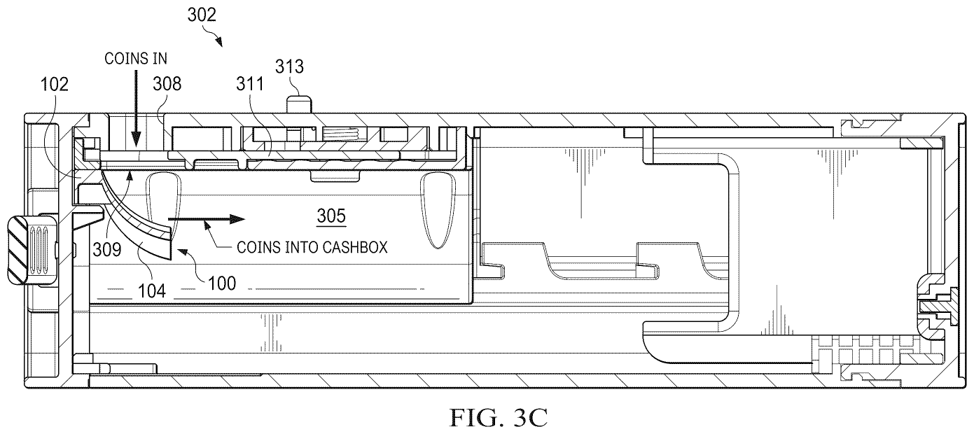

As one example, consider an automated payment apparatus, payment acceptor, coin acceptor, or currency recycler that includes a storage apparatus, e.g., a cashbox, for storing coins deposited into the machine. FIGS. 3A-3C illustrate views of an example payment apparatus 300 including a saddle shaped deflector 100 within a storage apparatus 302 in accordance with this disclosure. FIG. 3A illustrates a perspective view of the payment apparatus 300, FIG. 3B illustrates a perspective view of an example storage apparatus 302, and FIG. 3C illustrates a cross-sectional view of a portion of the payment apparatus 300 that includes the storage apparatus 302.

As shown in FIG. 3A, the payment apparatus 300 includes an inlet 304 for receiving coins into an internal transport area of the payment apparatus 300 having one or more transportation paths including various transportation mechanisms for transporting the coins to the storage apparatus 302. The payment apparatus 300 can also include an outlet 306 for returning coins to a user, such as if the coins are rejected or if the coins are returned as change for a transaction. In various embodiments, the storage apparatus 302 can be referred to as a cashbox and is configured to hold a number of coins deposited into the cashbox. In some embodiments, the cashbox can be modular, in that the cashbox can be removed from the payment apparatus to allow for emptying of the cashbox once full, or to allow replacement of the cashbox with an empty cashbox. In some embodiments, the storage apparatus 302 can be outside the payment apparatus 300. For example, the storage apparatus 302 can be underneath the payment apparatus 300 where an exit slot of the payment apparatus 300 is aligned with a coin deposit opening 308 of the storage apparatus 302.

As shown in FIG. 3B, the storage apparatus 302 includes the coin deposit opening 308 for receiving coins into the storage apparatus 302. As shown in FIG. 3C, the saddle shaped deflector 100 includes the attachment bar 102 and the deflection ramp 104, such as described with respect to FIGS. 1A-1D. The deflection ramp 104 of the saddle shaped deflector 100 is shaped to be a curved surface without any flat, parallel, or perpendicular surface. The shape of the deflection ramp 104 of the saddle shaped deflector 100 allows for objects to be directed into specific parts of the storage apparatus to achieve efficient filling throughout the storage apparatus.

The storage apparatus 302 can have a specified filling capacity. For example, a cashbox like the storage apparatus 302 may need to be filled with a large number of coins, such as 600 mixed denomination Euro coins (or other numbers of coins and/or other coin types) to fulfill its specification. In some cases, the coin deposit opening 308 may be positioned in a location necessitated by other factors, such as a location of a coin exit slot of the payment apparatus 300 or other factors. The configuration of the cashbox can be determined according to a variety of factors. For instance, the height of the cashbox can be necessitated by the constraint that the cashbox fit into the payment apparatus. The storage apparatus 302 that includes the saddle shape deflector 100 has the advantage of greater filling efficiency over configurations of storage apparatus 302 that have no deflector or a non-saddle shaped deflector as the saddle shaped deflector 100 will provide improved coin distribution over the configurations with no deflector or a non-saddle shaped deflector, which suffer from inefficient coin piling and poor coin distribution.

For example, in configuration with a non-saddle shaped deflector, as coins enters the cashbox the coins may bounce off flat, straight, angular portions of the ramp surface, and may hit the top wall of the cashbox and fall down into an area of the cashbox 502 underneath or very close to the opening and the ramp. This bouncing can remove the energy from the object and cause poor and inefficient piling of the coins in the cashbox, and can cause the opening or entry of the storage apparatus to be obstructed as objects are stacked underneath the opening, preventing more objects to be deposited into the storage apparatus even though the storage apparatus is not yet full. Alternate configurations implementing a ramp shape on the floor of the cashbox do not have the effect of improving the coin distribution or fill capacity. Rather, as soon as the coin level exceeds the tallest part of the ramp shape, the cashbox displays the same inefficient filling as having no deflector.

The saddle shaped deflector 100 of this disclosure, however, beneficially allows for efficient filling and distribution of a large number of coins in a confined area. The sloping shape of the saddle shaped deflector 100 prevents objects from bouncing and hitting other surrounding parts at the opening or entry of the storage apparatus. For example, the curved surface of the deflection ramp 104 of the deflector 100 allows objects such as a coin to be directed to the rear corners of the storage apparatus 302. The geometry of the surface of the deflection ramp 104 thus allows the deflector 100 to work efficiently, with the sloping form stopping coins from bouncing and directing coins such that the storage apparatus 302 can be filled to its specified filling capacity.

The direction in which coins flow off the deflection ramp 104 is assisted by the form of the deflection ramp 104 being negatively contoured away from the center axis of the deflector and because the deflection ramp 104 is symmetrical. This dished shape can also prevent coins from tipping upon impact with the deflector 100. This is advantageous, as this prevents a double impact of the coins on the deflector 100 before progressing to the rear of the storage apparatus. In this way, the coins lose the least amount of kinetic energy and can travel further into the storage apparatus, aiding the even distribution of the coins within the storage apparatus.

As also shown in FIG. 3C, the deflector 100 can be attached to a cover 305 via the attachment bar 102. The cover 305 has an aperture 309 that is positioned below the coin deposit opening 308 to allow coins to pass through the cover 305 and into the storage apparatus 302. Also, as shown in FIG. 3C, the storage apparatus 302 can include a mechanical shutter mechanism with a shutter 311 that opens and closes the coin deposit opening 308 via an actuator pin 313. The actuator pin 313 is shown in FIGS. 3B and 3C in a forward or shutter open position in a slot 314, but it will be understood that the actuator pin 313 can move in the slot 314 such that the shutter 311 is in a closed position that blocks the coin deposit opening 308. In various embodiments, the shutter mechanism can be spring loaded and if the cashbox 302 is not engaged with the payment device 300, the shutter 311 is in a normally closed position with the actuator pin 313 at the other end of the slot 314 in FIG. 3B. The action of installing the cashbox 302 under the payment device 300 causes the actuator pin 313 to move in slot 314 to the forward position as in FIG. 3B and open the shutter 311.

Although FIGS. 3A-3C illustrate views of an example payment apparatus including a saddle shaped deflector within a storage apparatus, various changes may be made to FIGS. 3A-3C. For example, payment apparatuses and machines can come in a variety of configurations, and this disclosure is not limited to any particular configuration of a payment apparatus or machine. Additionally, it will be understood that the saddle shaped deflector 100 and the storage apparatus 302 can be configured to operate within a variety of environments, such as a variety of other types of machines or apparatuses, and can be used to transport and deposit a variety of different objects into and within the storage apparatus 302, depending on the type of apparatus or machine in which the saddle shaped deflector 100 and the storage apparatus 302 are used.

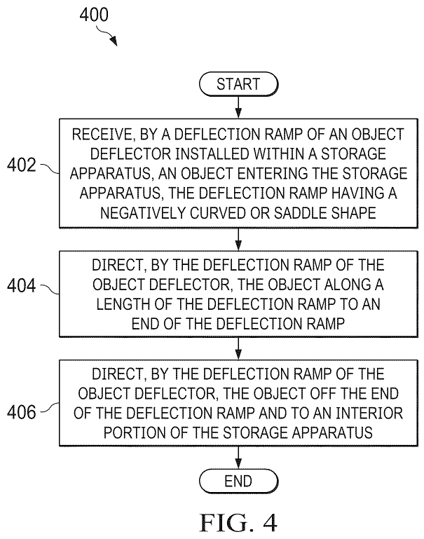

FIG. 4 illustrates an example method 400 for an object deflector in accordance with this disclosure. The method 400 can be used with the object deflector 100 having a saddle shape as described in this disclosure.

As described in this disclosure, the object deflector can be installed within a storage apparatus, such as storage apparatus 202 or 302, and can include a deflection ramp. As also described in this disclosure, the object deflector can include an attachment portion for coupling the object deflector to the storage apparatus and the deflection ramp can extend from the attachment portion. As described in this disclosure, the attachment portion can be an elongated bar extending at least a width of the deflection ramp, and, in various embodiments, can include coupling apertures for coupling the object deflector to the storage apparatus.

At step 402, an object that has entered the storage apparatus is received by the deflection ramp of the object deflector. In various embodiments, the object deflector is installed below an entrance into the storage apparatus and catches objects falling into the storage apparatus. At step 404, the object is directed along a length of the deflection ramp. As also described in this disclosure, in various embodiments, the deflection ramp can include a curved surface without flat, parallel, or perpendicular surfaces. As also described in this disclosure, in various embodiments, the deflection ramp is symmetrical.

At step 406, the object is directed to an interior portion of the storage apparatus. As described in this disclosure, in some embodiments, the storage apparatus can be an automated payment apparatus and the object can be a coin, and, in such embodiments, the object deflector receives the coin on the deflection ramp and directs the coin to the interior portion of the storage apparatus for filling the interior portion of the storage apparatus with a plurality of other coins.

Although FIG. 4 illustrates one example of a method 400 for an object deflector, various changes may be made to FIG. 4. For example, while shown as a series of steps, various steps in FIG. 4 could overlap, occur in parallel, occur in a different order, or occur any number of times (including zero times). For example, steps 402, 404, and 406 can be performed any number of times, such that a plurality of objects are received into the storage apparatus and by the object deflector, for instance until the storage apparatus is filled to a particular capacity. As such, the method 400 may also include removal and/or emptying of the storage apparatus once filled to capacity.

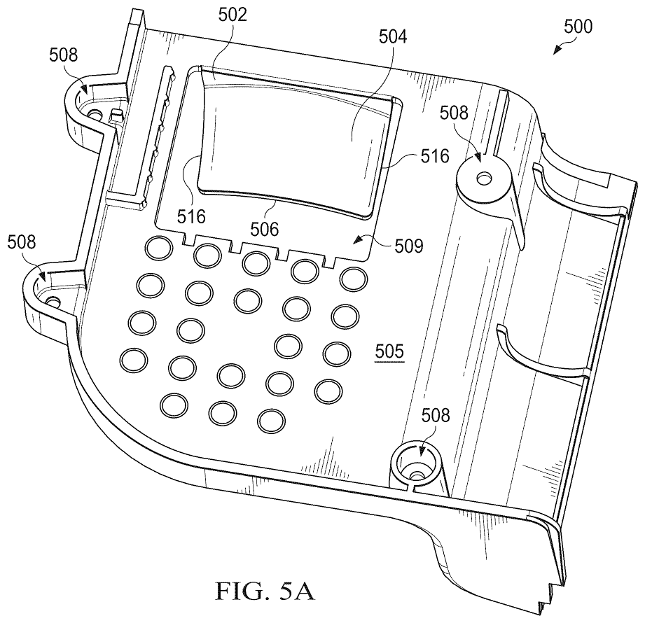

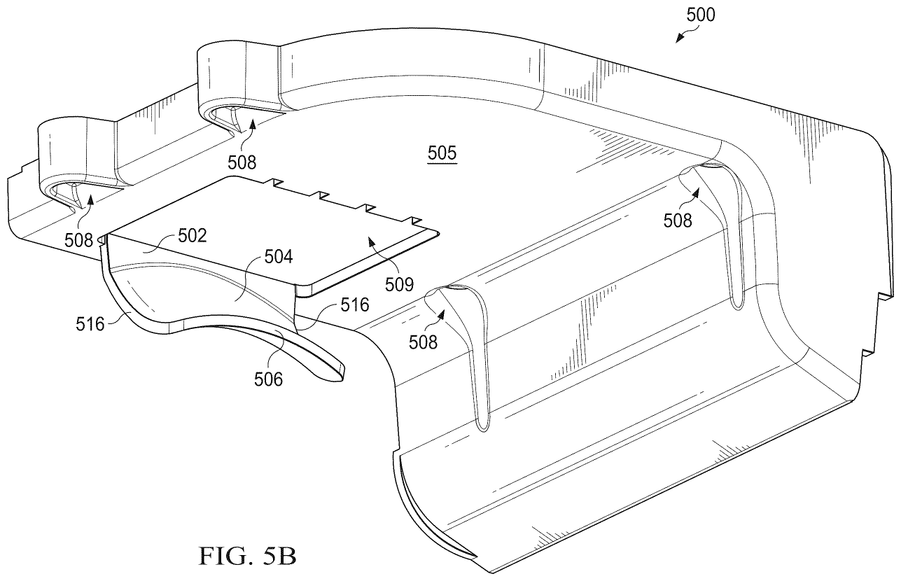

FIGS. 5A and 5B illustrate views of another example saddle shaped deflector 500 for a storage apparatus in accordance with this disclosure. FIG. 5A is a top perspective view of the saddle shaped deflector 500, and FIG. 5B is a bottom perspective view of the saddle shaped deflector 500. It will be understood that the saddle shaped deflector 500 can be used in a variety of environments to receive and transition objects into a storage apparatus. For example, the saddle shaped deflector 500 could be used in various apparatuses in which objects are deposited and accumulated into a designated storage area, such as automated currency or payment machines, gaming machines that transport and/or store small objects such as marbles, food/produce storage machines that store small items (e.g., coffee beans), quarrying equipment where rocks, gravel, coal, sand, salt, etc. are stacked in a given area, candy/gumball machines, toy machines, etc.

As shown in FIGS. 5A and 5B, the saddle shaped deflector 500, instead of including an attachment bar like the saddle shaped deflector 100 of this disclosure, includes a top portion 502 of a deflection ramp 504 that is integrated directly with an attachment portion or cover 505. The cover 505 is configured to couple the saddle shaped deflector 500 to a storage apparatus. For example, the cover 505 may be coupled to the storage apparatus via coupling apertures 508. Like the saddle shaped deflector 100 described in this disclosure, the saddle shaped deflector 500 can receive objects via a deposit opening such as an aperture, tunnel, chute, and/or other structures of a storage apparatus that allow for the objects to be deposited into the storage apparatus. For instance, the storage apparatus could be part of an apparatus or machine that receives the objects and transports the objects via an object transportation system through the machine and into the storage apparatus. An aperture 509 in the cover 505 can be positioned below such aperture, tunnel, chute, and/or other structures of a storage apparatus so that coins deposited in the storage apparatus enter through the aperture 509 and are deflected via the deflection ramp 504.

The saddle shaped deflection ramp 504 has a front edge 506 and two side edges 516. An object received into the storage apparatus comes into contact with the saddle shaped deflector 500, being initially received by a portion of a deflection ramp 504. The objects received onto the deflection ramp 504 slide off either the front edge 506 or one of the side edges 516 of the deflection ramp 504 and are directed further into an interior of the storage apparatus. The deflection ramp 504 of the saddle shaped deflector 500 is a curved surface without any flat, parallel, or perpendicular surfaces, as also described with respect to FIGS. 1A-1D. The surface does not contain any straight lines or angles. In one embodiment the curved surface of the deflection ramp 504 of the deflector 500 is negatively curved. In one embodiment the curved surface of the deflection ramp 504 of the deflector 500 is a hyperbolic paraboloid, which is a negatively curved surface without any flat, parallel, or perpendicular surfaces.

The saddle shape of the deflection ramp 504 allows for objects to be directed into specific parts of the storage apparatus to achieve efficient filling throughout the storage apparatus. The shape of the deflection ramp 504 of the saddle shaped deflector 500 allows for objects to be directed into specific parts of the storage apparatus to achieve efficient filling throughout the storage apparatus. This continuous sloping shape also prevents the objects from bouncing and hitting other surrounding parts at the opening or entry of the storage apparatus as bouncing of an object from flat and angular surfaces can remove the energy from the object as it moves into storage area leading to inefficient piling and can cause the opening or entry of the storage apparatus to be obstructed, preventing more objects to be deposited into the storage apparatus, even though the storage apparatus is not yet full.

The direction in which the object flows off the deflection ramp 504 is assisted by the form of the deflection ramp 504 being negatively contoured away from the central axis of the deflector (i.e., the object travel direction) and because the deflection ramp 504 is symmetrical about a vertical plane through this central axis. This dished shape can also prevent objects from tipping upon impact with the deflector 500. This is advantageous, as this prevents a double impact of the object on the deflector 500 before progressing to the rear of the storage apparatus. In this way, any loss of kinetic energy by the object is minimized and the object can travel further into the storage apparatus, aiding the even distribution of the objects within the storage apparatus. In other words, parts of the storage apparatus farther from the opening will fill first, allowing a larger number of objects to enter the storage apparatus as the objects pile from the farther areas of the storage area back to near the deflection ramp 504.

The cover 505 shields internal components of the cashbox from coins deflected off the ramp after entering the cashbox. As noted above, the deflection ramp 504 is integrated directly into the cover 505, e.g., it can be molded as a single piece. The cover serves a dual purpose, both to protect internal components from impact of any bouncing coins as well as eliminate any potential for coin trapping by those components. In this assembly, the internal components include a mechanical shutter mechanism for the entrance slot and a locking assembly to secure the cashbox in its housing, as described with respect to the various embodiments of this disclosure.

Other properties of the deflection ramp 504 can be the same as the deflection ramp 104 described in this disclosure. For example the deflection ramp 504 can have the same or similar properties such as the linear height 119, the linear height 121, the thickness 123, the radius of curvature 125, the linear width 127, and the linear length, the linear height 113, the radius of curvature 107, the angle 109, and the linear height 111, as described with respect to FIGS. 1A-1D.

Although FIGS. 5A and 5B illustrate one example of a saddle shaped deflector 500, various changes may be made to FIGS. 5A and 5B. For example, it will be understood that FIGS. 5A and 5B are merely examples to demonstrate an example construction of the deflector 500, and other arrangements can be used while retaining the general and beneficial shape of the saddle shaped deflector 500 without departing from the scope of this disclosure. The saddle shaped deflector 500 can be made from a variety of materials that allow for the surface of the deflection ramp 504 to be smooth.

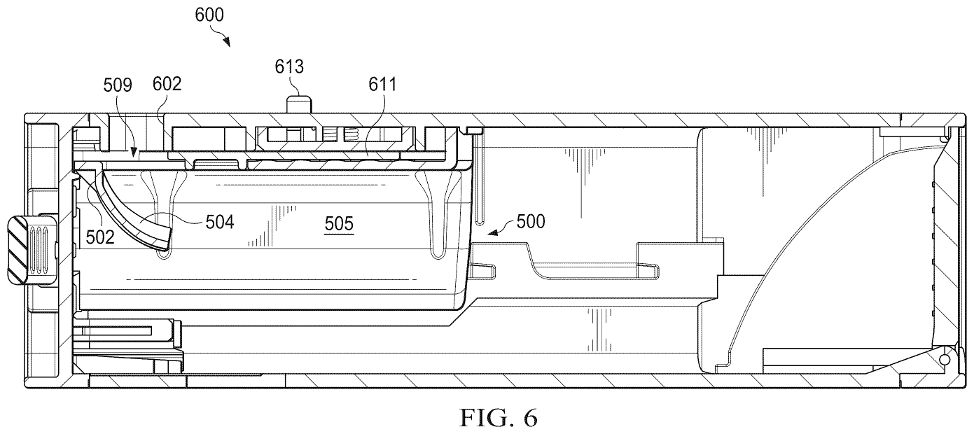

FIG. 6 illustrates a cross-sectional view of a storage apparatus 600 of a payment apparatus, such as the payment apparatus 300, and that includes the saddle shaped deflector of FIGS. 5A and 5B. In various embodiments, the storage apparatus 600 can be referred to as a cashbox and is configured to hold a number of coins deposited into the cashbox. In some embodiments, the cashbox can be modular, in that the cashbox can be removed from the payment apparatus to allow for emptying of the cashbox once full, or to allow replacement of the cashbox with an empty cashbox. In some embodiments, the storage apparatus 600 can be outside a payment apparatus. For example, the storage apparatus 600 can be underneath the payment apparatus where an exit slot of the payment apparatus is aligned with a coin deposit opening 602 of the storage apparatus 600.

As shown in FIG. 6, like the storage apparatus 302, the storage apparatus 600 includes the coin deposit opening 602 for receiving coins into the storage apparatus 600. As further shown in FIG. 6, the saddle shaped deflector 500 includes the cover 505 and the deflection ramp 504, such as described with respect to FIGS. 5A and 5B. The deflection ramp 504 of the saddle shaped deflector 100 is shaped to be a curved surface without any flat, parallel, or perpendicular surface. The shape of the deflection ramp 504 of the saddle shaped deflector 500 allows for objects to be directed into specific parts of the storage apparatus to achieve efficient filling throughout the storage apparatus.

The storage apparatus 600 can have a specified filling capacity. For example, a cashbox like the storage apparatus 600 may need to be filled with a large number of coins, such as 600 mixed denomination Euro coins (or other numbers of coins and/or other coin types) to fulfill its specification. In some cases, the coin deposit opening 602 may be positioned in a location necessitated by other factors, such as a location of a coin exit slot of the payment apparatus or other factors. The configuration of the cashbox can be determined according to a variety of factors. For instance, the height of the cashbox can be necessitated by the constraint that the cashbox fit into the payment apparatus. The storage apparatus 600 that includes the saddle shape deflector 500 has the advantage of greater filling efficiency over configurations of storage apparatus 600 that have no deflector or a non-saddle shaped deflector as the saddle shaped deflector 500 will provide improved coin distribution over the configurations with no deflector or a non-saddle shaped deflector, which suffer from inefficient coin piling and poor coin distribution.

For example, in configurations with a non-saddle shaped deflector, as coins enters the cashbox the coins may bounce off flat, straight, angular portions of the ramp surface, and may hit the top wall of the cashbox and fall down into an area of the cashbox underneath or very close to the opening and the ramp. This bouncing can remove the energy from the object and cause poor and inefficient piling of the coins in the cashbox, and can cause the opening or entry of the storage apparatus to be obstructed as objects are stacked underneath the opening, preventing more objects to be deposited into the storage apparatus even though the storage apparatus is not yet full. Alternate configurations implementing a ramp shape on the floor of the cashbox do not have the effect of improving the coin distribution or fill capacity. Rather, as soon as the coin level exceeds the tallest part of the ramp shape, the cashbox displays the same inefficient filling as having no deflector.

The saddle shaped deflector 500 of this disclosure, however, beneficially allows for efficient filling and distribution of a large number of coins in a confined area. The sloping shape of the saddle shaped deflector 500 prevents objects from bouncing and hitting other surrounding parts at the opening or entry of the storage apparatus. For example, the curved surface of the deflection ramp 504 of the deflector 100 allows objects such as a coin to be directed to the rear corners of the storage apparatus 600. The geometry of the surface of the deflection ramp 504 thus allows the deflector 500 to work efficiently, with the sloping form stopping coins from bouncing and directing coins such that the storage apparatus 600 can be filled to its specified filling capacity.

The direction in which coins flow off the deflection ramp 504 is assisted by the form of the deflection ramp 504 being negatively contoured away from the center axis of the deflector and because the deflection ramp 504 is symmetrical. This dished shape can also prevent coins from tipping upon impact with the deflector 500. This is advantageous, as this prevents a double impact of the coins on the deflector 500 before progressing to the rear of the storage apparatus. In this way, the coins lose the least amount of kinetic energy and can travel further into the storage apparatus, aiding the even distribution of the coins within the storage apparatus. As shown in FIG. 6, the storage apparatus can include a mechanical shutter mechanism including a shutter 611 and an actuator pin 613, as described with respect to FIGS. 3A-3C.

Although FIG. 6 illustrates a cross-sectional view of one example of a storage apparatus 600 of a payment apparatus, various changes may be made to FIG. 6. For example, payment apparatuses and machines can come in a variety of configurations, and this disclosure is not limited to any particular configuration of a payment apparatus or machine. Additionally, it will be understood that the saddle shaped deflector 500 and the storage apparatus 600 can be configured to operate within a variety of environments, such as a variety of other types of machines or apparatuses, and can be used to transport and deposit a variety of different objects into and within the storage apparatus 600, depending on the type of apparatus or machine in which the saddle shaped deflector 500 and the storage apparatus 600 are used.

In one example embodiment, an object deflector for installation within a storage apparatus comprises an attachment portion for coupling the object deflector to the storage apparatus and a deflection ramp extending from the attachment portion and operable to receive an object entering the storage apparatus and direct the object to an interior portion of the storage apparatus, wherein the deflection ramp is a saddle shape.

In one or more of the above examples, the saddle shape is a hyperbolic paraboloid.

In one or more of the above examples, the deflection ramp includes a curved surface without flat, parallel, or perpendicular surfaces.

In one or more of the above examples, the curved surface of the deflector ramp includes no straight lines or angles.

In one or more of the above examples, the deflection ramp is symmetrical.

In one or more of the above examples, the storage apparatus is an automated payment apparatus and the object is a coin, and wherein the object deflector is operable to receive the coin on the deflection ramp and direct the coin to the interior portion of the storage apparatus for filling the interior portion of the storage apparatus with a plurality of other coins.

In one or more of the above examples, the attachment portion is an elongated bar extending at least a width of the deflection ramp.

In one or more of the above examples, the elongated bar includes coupling apertures for coupling the object deflector to the storage apparatus.

In one or more of the above examples, the object deflector is configured to be installed below an entrance into the storage apparatus.

In another example embodiment, a method of an object deflector installed within a storage apparatus, wherein the object deflector includes an attachment portion for coupling the object deflector to the storage apparatus and a deflection ramp extending from the attachment portion, comprises receiving, by the deflection ramp of the object deflector, an object entering the storage apparatus, directing, by the deflection ramp, the object along a length of the deflection ramp, and directing, by the deflection ramp, the object to an interior portion of the storage apparatus, wherein the deflection ramp of the object deflector is saddle shaped.

In one or more of the above examples, the saddle shape is a hyperbolic paraboloid.

In one or more of the above examples, the deflection ramp includes a curved surface without flat, parallel, or perpendicular surfaces.

In one or more of the above examples, the curved surface of the deflector ramp includes no straight lines or angles.

In one or more of the above examples, the deflection ramp is symmetrical.

In one or more of the above examples, the storage apparatus is an automated payment apparatus and the object is a coin, and the method further comprises receiving the coin on the deflection ramp and directing the coin to the interior portion of the storage apparatus for filling the interior portion of the storage apparatus with a plurality of other coins.

In one or more of the above examples, the attachment portion is an elongated bar extending at least a width of the deflection ramp.

In one or more of the above examples, the elongated bar includes coupling apertures for coupling the object deflector to the storage apparatus.

In one or more of the above examples, the attachment portion includes a cover that shields internal components of the storage apparatus from an object being deflected off the deflection ramp.

In one or more of the above examples, the deflection ramp is integral with the cover.

In one or more of the above examples, the storage apparatus includes a shutter actuated by an actuator pin moving in a slot to open and close an aperture of the storage apparatus for receiving coins.

In one or more of the above examples, the shutter is spring loaded and if the storage apparatus is not engaged with the payment device, the shutter is in a normally closed position with the actuator pin at one end of the slot.

In one or more of the above examples, an action of installing the storage apparatus in a payment device causes the actuator pin to move to a forward position at the other end of the slot and open the shutter.

As used throughout this specification, the terms currency denomination, denomination of currency, valuable document, currency bill, bill, banknote, note, bank check, paper money, paper currency, coin, coinage, and cash may be used interchangeably herein to refer to a type of a negotiable instrument or any other writing that evidences a right to the payment of a monetary obligation, typically issued by a central banking authority. Payment apparatus/acceptor and coin apparatus/acceptor may be used interchangeably herein to refer to a type of monetary acceptor unit that may verify inserted banknote in a banknote acceptor or coin in coin acceptor. A payment acceptor may comprise both a banknote acceptor and coin acceptor and other electronic payment acceptance devices.

Although this disclosure has been described with reference to various example embodiments, various changes and modifications may be suggested to one skilled in the art. It is intended that this disclosure encompass such changes and modifications as fall within the scope of the appended claims. The present disclosure should not be read as implying that any particular element, step, or function is an essential element, step, or function that must be included in the scope of the claims. Moreover, the claims are not intended to invoke 35 U.S.C. § 112(f) unless the exact words “means for” are followed by a participle.

What is claimed is:

1. An object deflector for installation within a storage apparatus, the object deflector comprising:
an attachment portion for coupling the object deflector to the storage apparatus; and
a deflection ramp extending from the attachment portion and operable to receive an object entering the storage apparatus and direct the object to an interior portion of the storage apparatus,
wherein the deflection ramp is a saddle shape.

2. The object deflector of claim 1, wherein the saddle shape is a hyperbolic paraboloid.

3. The object deflector of claim 1, wherein the deflection ramp includes a curved surface without flat, parallel, or perpendicular surfaces.

4. The object deflector of claim 3, wherein the curved surface of the deflection ramp includes no straight lines or angles.

5. The object deflector of claim 1, wherein the deflection ramp is symmetrical.

6. The object deflector of claim 1, wherein the storage apparatus is an automated payment apparatus and the object is a coin, and wherein the object deflector is operable to receive the coin on the deflection ramp and direct the coin to the interior portion of the storage apparatus for filling the interior portion of the storage apparatus with a plurality of other coins.

7. The object deflector of claim 1, wherein the attachment portion is an elongated bar extending at least a width of the deflection ramp.

8. The object deflector of claim 7, wherein the elongated bar includes coupling apertures for coupling the object deflector to the storage apparatus.

9. The object deflector of claim 1, wherein the object deflector is configured to be installed below an entrance into the storage apparatus.

10. The object deflector of claim 1, wherein the attachment portion includes a cover that shields internal components of the storage apparatus from the object being deflected off the deflection ramp.

11. The object deflector of claim 10, wherein the deflection ramp is integral with the cover.

12. A method of an object deflector installed within a storage apparatus, wherein the object deflector includes an attachment portion for coupling the object deflector to the storage apparatus and a deflection ramp extending from the attachment portion, the method comprising:
receiving, by the deflection ramp of the object deflector, an object entering the storage apparatus;
directing, by the deflection ramp, the object along a length of the deflection ramp; and
directing, by the deflection ramp, the object to an interior portion of the storage apparatus,
wherein the deflection ramp of the object deflector is a saddle shape.

13. The method of claim 12, wherein the saddle shape is a hyperbolic paraboloid.

14. The method of claim 12, wherein the deflection ramp includes a curved surface without flat, parallel, or perpendicular surfaces.

15. The method of claim 14, wherein the curved surface of the deflection ramp includes no straight lines or angles.

16. The method of claim 12, wherein the deflection ramp is symmetrical.

17. The method of claim 12, wherein the storage apparatus is an automated payment apparatus and the object is a coin, the method further comprising receiving the coin on the deflection ramp and directing the coin to the interior portion of the storage apparatus for filling the interior portion of the storage apparatus with a plurality of other coins.

18. The method of claim 12, wherein the attachment portion is an elongated bar extending at least a width of the deflection ramp.

19. The method of claim 18, wherein the elongated bar includes coupling apertures for coupling the object deflector to the storage apparatus.

20. The method of claim 12, wherein the attachment portion includes a cover that shields internal components of the storage apparatus from the object being deflected off the deflection ramp, and wherein the deflection ramp is integral with the cover.
